(19) United States
(12) Patent Application Publication
(10) Pub. No.: US 2026/0283100 A1
(43) Pub. Date: Sep. 24, 2026

(54) LITTER BOX

(71) Applicant: PetPivot INC, PORTLAND, OR (US)

(72) Inventor: TIEQIANG TANG, Shaoyang City (CN)

(21) Appl. No.: 19/686,810

(22) Filed: May 25, 2026

Related U.S. Application Data
(63) Continuation of application No. 18/392,864, filed on Dec. 21, 2023, now Pat. No. 12,685,291.

(30) Foreign Application Priority Data
Dec. 14, 2023 (CN) 202323406907.1

(51) Int. Cl. A01K 1/01; A01K 29/00; G01G 23/00

(52) U.S. Cl. CPC A01K 1/0114; A01K 29/005; G01G 23/002

(57) ABSTRACT

The present disclosure provides a litter box. The litter box includes a litter box main body, and a supporting platform. The supporting platform includes a first supporting leg. A bayonet is arranged on the supporting platform. The first supporting leg is provided with a clamping member, and the clamping member passes through the bayonet from a bottom of the supporting platform and is clamped to the supporting platform to connect the first supporting leg to the supporting platform.

### CROSS-REFERENCE TO RELATED APPLICATIONS

This application is a continuation application of U.S. application serial No. 18/392,864, filed on Dec. 21, 2023, the content of which is incorporated by reference herein.

### TECHNICAL FIELD

The present disclosure relates to a litter box, which is applied to the technical field of pet supplies.

### BACKGROUND

At present, more and more people like to keep pets in their spare time. In the process of keeping pets, the problem of excretion of the pets has always bothered owners. Cats are taken as an example. A litter box or a cat toilet is usually used by pet cats, but the litter box or the cat toilet needs to be cleaned timely. Otherwise, for people, the strong odor of excrements of the cats will affect indoor air; and for cats, they will no longer be willing to defecate in the litter box or the cat toilet and will change their defection places or refrain from defecating. Those who are familiar with cats know that if a cat does not defecate for three days, its health will be directly affected.

Therefore, some existing intelligent litter boxes or cat toilets are provided with weighing devices to record and visually reflect a weight and defecation information of a cat by monitoring a weight of a box body, so as to know defecation time and a defecation amount and learn about a basic health status of the cat.

At present, the weighing sensor of the existing litter box is arranged between a supporting leg and a supporting seat. The supporting leg is configured to support the supporting seat in a suspended state, and the supporting leg is fixedly connected to the supporting seat. The arrangement of the weighing sensor has the following defects: 1. When the ground is uneven, this arrangement will be affected by the uneven ground, leading to a zero drift. As a result, an error occurs in measurement of the weighing sensor. 2. Due to the contact between the supporting leg and the ground, the weighing sensor can only work on the hard ground, and the ground needs to be even, otherwise, the weighing sensor is inaccurate in measurement. 3. If a user directly drags and moves the product on the ground, the weighing sensor will be easy to damage, causing inaccurate subsequent measurement of the weighing sensor of the product, or causing a weight measurement function of the product to fail.

### SUMMARY

In view of the technical problems in the prior art mentioned above.

The technical solution adopted by the present disclosure to solve the technical problem is as follows.

A litter box, wherein the litter box includes a litter box main body, and a supporting platform. The supporting platform includes a first supporting leg. A bayonet is arranged on the supporting platform. The supporting leg is provided with a clamping member, and the clamping member passes through the bayonet from a bottom of the supporting platform and is clamped to the supporting platform to connect the first supporting leg to the supporting platform.

Beneficial effects of the present disclosure are as follows. The present disclosure provides a litter box. The litter box includes a litter box main body and a supporting platform. The supporting platform includes a first supporting leg. A bayonet is arranged on the supporting platform. The first supporting leg is provided with a clamping member, and the clamping member passes through the bayonet from a bottom of the supporting platform and is clamped to the supporting platform to connect the first supporting leg to the supporting platform. The structure mainly solves the problem of quickly mounting the first supporting leg on the supporting platform without adding any other components, thereby simplifying the installation procedure.

### BRIEF DESCRIPTION OF THE DRAWINGS

FIG. 1 is a schematic structural diagram of a litter box according to the present disclosure;

FIG. 2 is a schematic structural diagram of a litter box according to the present disclosure;

FIG. 3 is a schematic structural diagram of a first supporting leg and a weighing sensor according to the present disclosure;

FIG. 4 is a partially schematic structural diagram of a litter box according to the present disclosure;

FIG. 5 is an enlarged view of A according to the present disclosure;

FIG. 6 is an enlarged view of B according to the present disclosure;

FIG. 7 is a three-dimensional diagram of a supporting seat according to the present disclosure;

FIG. 8 is an enlarged view of C according to the present disclosure;

FIG. 9 is a three-dimensional diagram of a litter box according to the present disclosure;

FIG. 10 is a three-dimensional diagram of a base according to the present disclosure;

FIG. 11 is a three-dimensional diagram of a roller according to the present disclosure;

FIG. 12 is a schematic structural diagram of a first shell according to the present disclosure;

FIG. 13 is a schematic structural diagram of a second shell according to the present disclosure.

### DETAILED DESCRIPTION OF THE EMBODIMENTS

In order to make the aims, technical solution and advantages of the present disclosure will be clearly, the present disclosure is further described below in combination with accompanying drawings and implementations. It should be understood that the specific embodiments described herein are intended only to explain the present disclosure and are not intended to define the present disclosure.

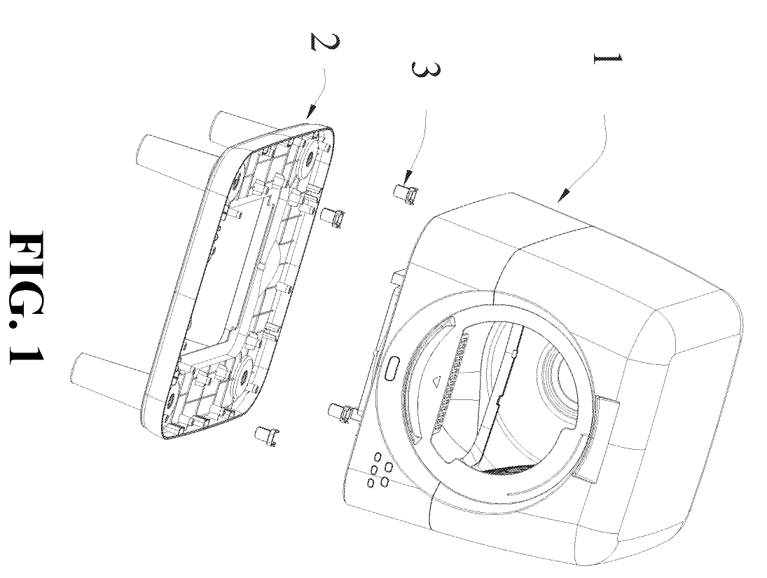

Referring to FIGS. 1-13, the present disclosure provides a litter box. As shown in FIGS. 1-3, the litter box includes a litter box main body 1, a supporting platform 2, a second supporting leg 3, and a weighing sensor 4. The weighing sensor 4 includes a connecting part 41 and a sensing part 42; the sensing part 42 of the weighing sensor is configured to sense a change in a weight of the litter box main body 1; the connecting part 41 of the weighing sensor is connected to the litter box main body 1; the sensing part 42 of the weighing sensor is connected to one end of the second supporting leg 3; and the other end of the second supporting leg 3 is abutted with the supporting platform 2. That is, one end of the second supporting leg is abutted with the supporting platform, the other end of the second supporting leg is connected to the sensing part of the weighing sensor, and the connecting part of the weighing sensor is connected to the litter box main body, so that the second supporting leg is always abutted with the supporting platform, and the weighing sensor will not be in a suspended state and can precisely detect a weight change generated by the litter box main body, which solves the problem of a measurement error of the weighing sensor in the prior art. It should be noted that the supporting platform refers to a platform surface. Due to the platform surface, when the litter box is on an uneven ground, the second supporting leg can always be abutted with the platform surface to ensure that the weighing sensor is not in the suspended state, so that even if the litter box is placed on the uneven ground or on a carpet or soft mat, and the weighing sensor will not have a detection error. This expands an application range of a user and improves the user experience.

In this embodiment, as shown in FIG. 4, the supporting platform 2 includes a weighing platform 21 and a first supporting leg 22; the weighing platform 21 is mounted on the first supporting leg 22; one end of the second supporting leg 3 is abutted with the weighing platform 21; the second supporting leg 3 is correspondingly arranged above the first supporting leg 22; and the litter box main body 1 is movably mounted on the weighing platform 21. That is, the first supporting leg supports the weighing platform and the litter box main body to be in a suspended state, so that the entire litter box is more aesthetically pleasing and three-dimensional. It should be noted that the litter box main body 1 is movably mounted on the weighing platform 21. First, the weighing sensor is protected during movement of the litter box. The supporting leg of the litter box in the prior art is integrated with a base. When a user directly drags and moves the product on the ground, the weighing sensor is easy to damage, causing the product to fail. In this embodiment, the litter box main body is movably connected to the weighing platform, which is convenient for first removing the litter box main body and then moving the supporting platform, so as not to damage the weighing sensor. Secondly, the weighing sensor in this embodiment is preferably set as a resistance strain sensor, and the sensing part is a resistance strain gauge. When a weight of the resistance strain gauge changes, the resistance strain gauge deforms slightly, making detection more accurate. If the weighing platform 21 is connected and fixed to the litter box main body, the resistance strain gauge cannot move, which will cause a small error in detection. Thirdly, the second supporting leg is mainly configured to be connected to the weighing platform 21, but it is not a main acting force for supporting the litter box main body. Therefore, the litter box main body 1 is movably mounted on the weighing platform 21, and the weighing platform 21 supports the litter box main body.

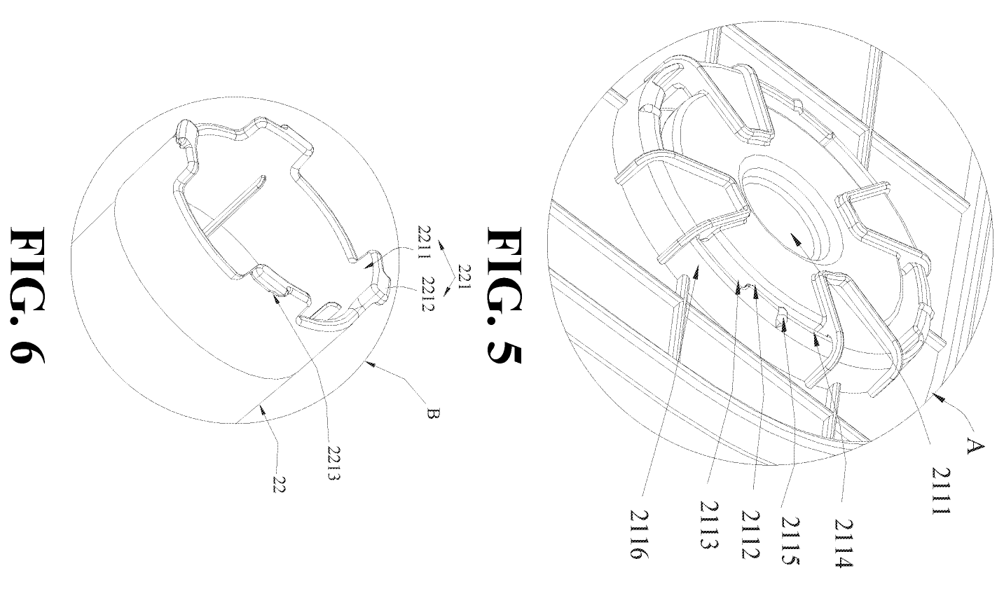

In this embodiment, as shown in FIG. 5, a mounting slot 2111 is arranged on the supporting platform 2, and one end of the second supporting leg 3 is mounted in the mounting slot 2111, so that the second supporting leg 3 achieves more stable supporting.

In this embodiment, as shown in FIGS. 4-6, a bayonet 2112 located around the mounting slot 2111 is arranged on the weighing platform 21; a clamping member 221 is arranged around the first supporting leg 22; and the clamping member 221 passes through the bayonet 2112 from a bottom of the weighing platform 21 and is clamped to the weighing platform 21 to connect the first supporting leg to the weighing platform 21. By the arrangement of the bayonet and the clamping member, it is convenient for the mounting of the first supporting leg.

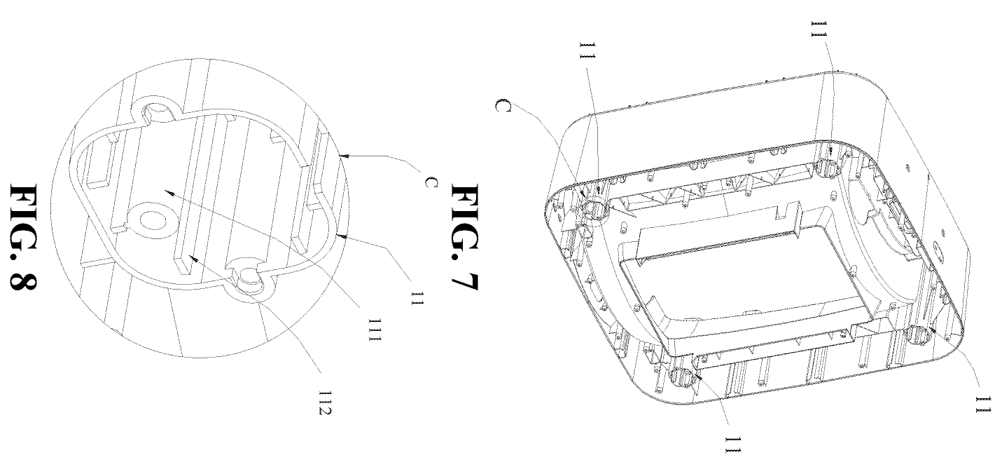

In this embodiment, as shown in FIGS. 5-6, the clamping member 221 includes a first bulge 2211 and a second bulge 2212; the first bulge 2211 is arranged around one end connected to the weighing platform 21, and the first bulge 2211 is arranged in a longitudinal extension direction of the first supporting leg 22; the second bulge 2212 is arranged on an outer side surface of the first bulge 2211; a gap 2113 and a third bulge 2114 are arranged at the bayonet 2112; the third bulge 2114 is arranged on an outer edge of the bayonet, and the third bulge 2114 is arranged towards an interior of the bayonet 2112; when the first supporting leg 22 is mounted on the weighing platform 21, after the second bulge 2212 passes through the gap 2113, the second bulge 2212 is rotated; and the second bulge 2212 can be clamped onto the third bulge 2114. This structure mainly achieves quickly mounting the first supporting leg on the weighing platform 21 without adding other components and reducing mounting procedures. In this embodiment, the first bulge and the second bulge are integrally molded, and the third bulge 2114 and the weighing platform 21 are integrally molded. The integrated molding is convenient for demolding.

In this embodiment, as shown in FIGS. 5-6, a surface of the third bulge 2114 is provided with a fourth bulge 2115; a surface of the second bulge 2212 is provided with a clamping slot 2213; after the second bulge passes through the gap, the second bulge 2212 can be rotated until the fourth bulge 2115 is clamped into the clamping slot 2213; or, a surface of the second bulge 2212 is provided with a fourth bulge 2115, and a surface of the third bulge 2114 is provided with a clamping slot 2213; and after the second bulge passes through the gap, the second bulge 2212 can be rotated until the fourth bulge 2115 is clamped into the clamping slot 2213. The design of this structure is mainly to prevent the first supporting leg from being separated from the weighing platform. This structure is convenient for the mounting of the first supporting leg and is simple. The fourth bulge 2115 and the third bulge 2114 of this embodiment are integrally molded. The integrated molding is convenient for demolding.

In this embodiment, as shown in FIGS. 5-6, a surface of the fourth bulge 2115 is an arc-shaped surface; a slot surface of the clamping slot 2213 is arranged in a manner of corresponding to the surface of the fourth bulge 2115; and when the fourth bulge 2115 is clamped into the clamping slot 2213, the second bulge 2212 is rotated, and the fourth bulge 2115 can be separated from the clamping slot 2213. This facilitates mounting and removal of the first supporting leg.

In this embodiment, as shown in FIGS. 4-6, the weighing platform 21 includes a weighing platform 21 and a mounting bottom shell 212; the mounting bottom shell 212 is mounted on the weighing platform 21; the weighing platform 21 is provided with a first boss 2116 facing the mounting bottom shell 212; the mounting bottom shell 212 is provided with a second boss 2122; the second boss 2122 is provided with a through hole 2121; the mounting slot 2111 is arranged on the first boss 2116; the through hole 2121 is arranged in a manner of corresponding to the mounting slot 2111; the second boss 2122 sleeves the first boss 2116; the litter box main body 1 is movably mounted on the mounting bottom shell 212; the mounting bottom shell 212 is provided with the through hole 2121; one end of the second supporting leg 3 is mounted in the mounting slot 2111 through the through hole 2121; and the first supporting leg 22 is arranged below the first boss 2116. This structural design is mainly to make a supporting force of the second supporting leg more stable.

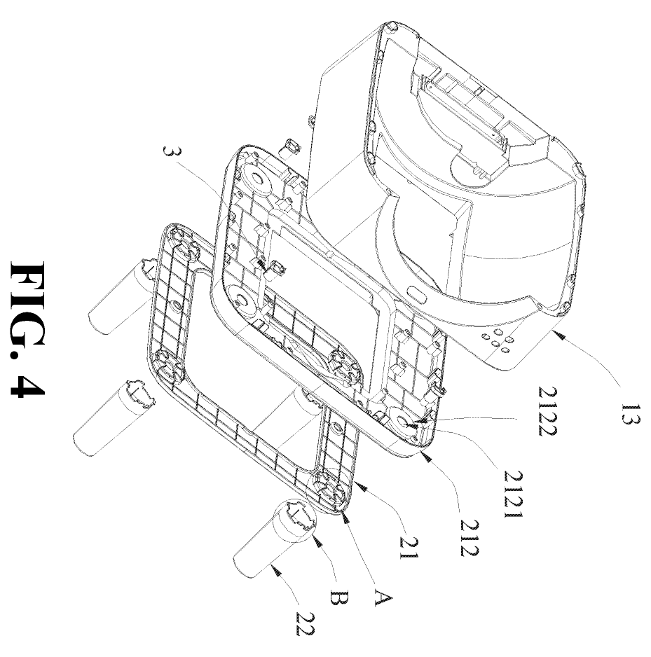

In this embodiment, as shown in FIG. 3, the connecting part 41 is arranged at a periphery of the sensing part 42; one end of the sensing part 42 is connected to the connecting part 41; and the sensing part 42 can move up and down relative to the connecting part 41. Therefore, the structure and mounting of the weighing sensor are clearer, and all connecting points are connected clearly. It is convenient for connection.

In this embodiment, the weighing sensor is a strain gauge type pressure sensor. A basic principle of the resistance strain pressure sensor is a strain effect of a resistor: When a conductor mechanically deforms, a resistance value of the conductor changes, which is referred to as “strain effect”. That is, the sensing part is a resistance strain gauge. When a weight of the litter box main body changes, the resistance value will change.

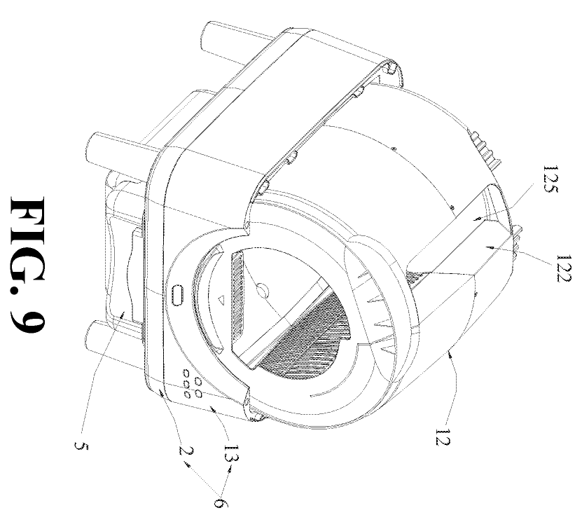

In this embodiment, as shown in FIGS. 7-8, a hollow mounting column 11 is arranged at a bottom of the litter box main body 1; the mounting column 11 is arranged in a manner of facing the second supporting leg 3; a supporting rib 111 is arranged around an inner side wall of a cavity of the mounting column 11; the connecting part 41 is mounted on a supporting end of the supporting rib 111; the sensing part 42 is located in the cavity of the mounting column 11; and when the weight of the litter box main body 1 increases, the mounting column 11 presses the connecting part 41, and the sensing part 42 can move in the cavity of the mounting column 11. This structure is more convenient for the mounting of the weighing sensor.

In this embodiment, as shown in FIGS. 7-8, a limiting column 112 is also arranged in the cavity of the mounting column 11; the limiting column 112 is arranged in a manner of corresponding to the sensing part 42; the limiting column 112 is slightly lower than the supporting end of the supporting rib 111; and the limiting column 112 can be configured to limit the sensing part 42. The limiting column 112 prevents an excessive pressure on the litter box and prevents an extremely high pressure on the sensing part of the weighing sensor to damage the weighing sensor.

In this embodiment, as shown in FIG. 4, the litter box main body 1, the weighing sensor 4, the second supporting leg 3, and the supporting platform 2 are arranged in sequence from top to bottom, which makes the mounting procedure clearer.

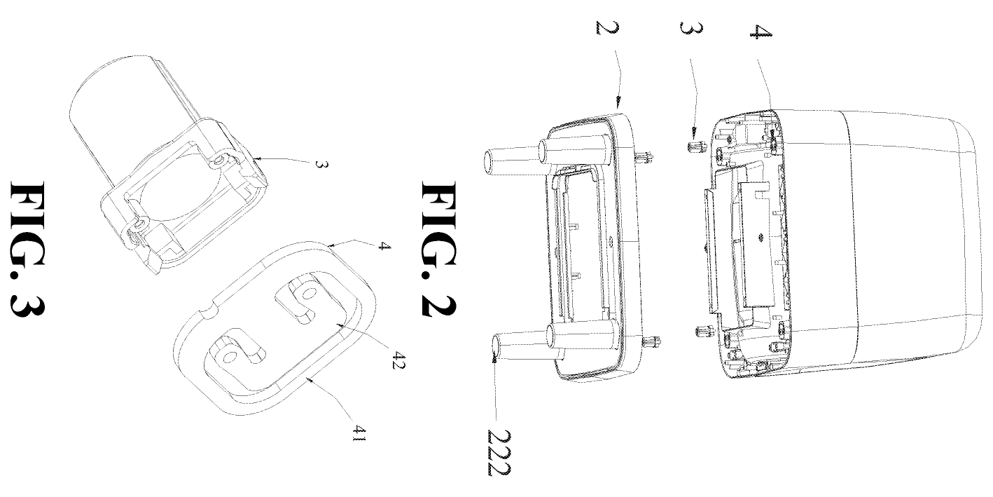

In this embodiment, as shown in FIG. 2, a foot pad 222 is arranged at a bottom of the first supporting leg 22 to protect the first supporting leg and prevent the first supporting leg from being damaged when the litter box is moved. The foot pad also has a mute effect during the movement of the litter box.

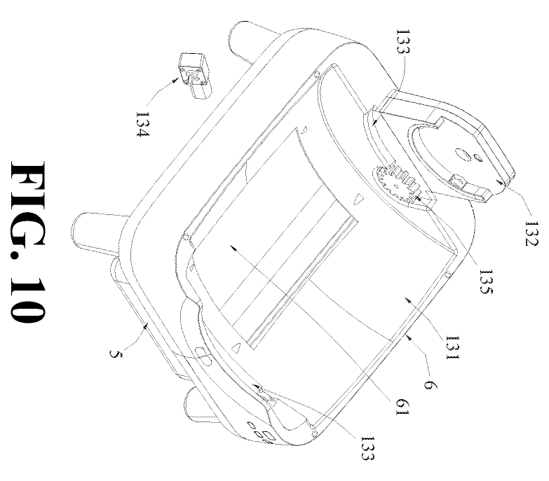

In this embodiment, as shown in FIG. 9, the litter box main body 1 includes a roller 12 and a supporting seat 13; the roller 12 is rotatably arranged on the supporting seat 13; the supporting seat 13 is arranged on the supporting platform 2; and the supporting seat 13 is connected to the supporting platform 2 to form a base 6. In this way, it is more convenient for mounting.

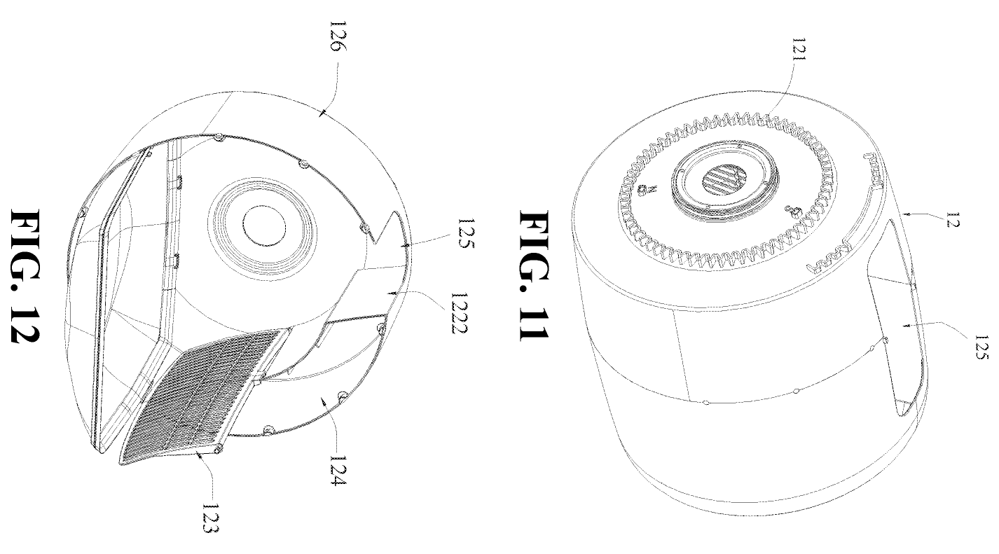

In this embodiment, as shown in FIGS. 10-11, the base 6 is provided with a supporting column 132; a rear end surface of the roller 12 is provided with a first gear 121; an upper surface of the base 6 is sunken downwards to form an avoiding slot 131 matched with the roller 12; one end of the supporting column 132 located in the avoiding slot 131 is opposite to an end surface of the roller 12; the avoiding slot 131 is provided with a carrying slot 133 for carrying two ends of the roller 12; the base 6 is provided with a motor 134 configured to drive the roller 12 to rotate; a rotating shaft of the motor 134 is connected with a second gear 135 engaged with the first gear 121; and the second gear 135 is located on the carrying slot 133. In this way, when the motor drives the second gear to rotate, the roller rotates through the first gear.

In this embodiment, as shown in FIGS. 10-11, an integral partition plate 122 and a sifter 123 are arranged in the roller 12; the integral partition plate 122 forms an accommodating slot 124 with an inner wall of the roller 12 and is integrally molded with the roller 12; a first opening 125 is formed in one side of the roller 12 far from a notch of the accommodating slot 124; when the roller 12 rotates, litter and waste are sifted through the sifter 123; and when the roller continues to rotate, the waste is rotated to the first opening 125 along the integral partition plate 122. In this embodiment, the integral partition plate and the roller 12 are integrally molded, which can effectively reduce the assembling process of the integral partition plate, reduce the production procedure of the litter box, and improve the production efficiency of the litter box. In this way, there is no joint between the integral partition plate and the roller 12, which can prevent the litter from being left in the joint and facilitate cleaning of a litter bin.

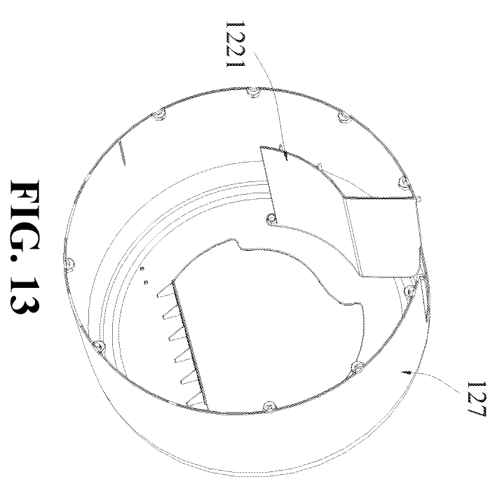

In this embodiment, as shown in FIGS. 12-13, the roller 12 includes a first shell 126 and a second shell 127 connected to the first shell 126; the integral partition plate 122 includes a first partition plate 1221 integrally molded with the first shell 126 and a second partition plate 1222 integrally molded with the second shell 127; and the first partition plate 1221 and the second partition plate 1222 form the integral partition plate 122 when the first shell is connected to the second shell 127. It can be understood that the first shell is a front half part of the roller 12, and the second shell is a rear half part of the roller 12. The first opening 125 is formed by connecting the first shell to the second shell. Of course, in other embodiments, the first shell and the second shell can also be a left half part and a right half part of the roller 12.

In this embodiment, as shown in FIGS. 12-13, the litter box further includes a collection box 5; the collection box 5 is arranged at a bottom of the base 6; a second opening 61 communicated to the collection box 5 is formed in the base 6; the roller 12 rotates relative to the base 6; and when the second opening 61 is opposite to the first opening 125, the waste falls into the collection box 5 through the second opening 61 and the first opening 125 in sequence. The collection box 5 is convenient to take down, and it is convenient for a user to clean waste of a pet regularly.

In this embodiment, the collection box 5 is detachably arranged at the bottom of the base 6. In this way, the collection box 5 can be suspended, and it is convenient to take out the collection box 5.

The above is only the preferred embodiments of the present disclosure, and is not intended to limit the present disclosure. Any modifications, equivalent replacements and improvements that are made within the spirit and principle of the present disclosure shall fall within the protection scope of the present disclosure.

1. A litter box, wherein the litter box comprises a litter box main body, and a supporting platform; the supporting platform comprises a first supporting leg; a bayonet is arranged on the supporting platform; the first supporting leg is provided with a clamping member; the clamping member passes through the bayonet from a bottom of the supporting platform and is clamped to the supporting platform to connect the first supporting leg to the supporting platform.

2. The litter box according to claim 1, wherein a mounting slot is arranged on the supporting platform; the bayonet is arranged on a peripheral side of the mounting slot on the supporting platform.

3. The litter box according to claim 2, wherein at least two bayonets are arranged on a peripheral side of the mounting slot on the supporting platform, and the first supporting leg is provided with at least two clamping members.

4. The litter box according to claim 3, wherein the at least two bayonets are arranged around the mounting slot on the supporting platform; the at least two clamping members are arranged around the first supporting leg.

5. The litter box according to claim 1, wherein the clamping member comprises a first bulge and a second bulge; the first bulge is arranged at one end connected to the supporting platform, and the first bulge is arranged in a longitudinal extension direction of the first supporting leg; the second bulge is arranged on an outer side surface of the first bulge; a gap and a third bulge are arranged at the bayonet; the third bulge is arranged on an outer edge of the bayonet, and the third bulge is arranged towards an interior of the bayonet; when the first supporting leg is mounted on the supporting platform, after the second bulge passes through the gap, the second bulge is rotated, and the second bulge is clamped onto the third bulge.

6. The litter box according to claim 5, wherein a surface of the third bulge is provided with a fourth bulge; a surface of the second bulge is provided with a clamping slot; after the second bulge passes through the gap, the second bulge is rotated until the fourth bulge is clamped into the clamping slot; or, a surface of the second bulge is provided with a fourth bulge, and a surface of the third bulge is provided with a clamping slot; and after the second bulge passes through the gap, the second bulge is rotated until the fourth bulge is clamped into the clamping slot.

7. The litter box according to claim 6, wherein a surface of the fourth bulge is an arc-shaped surface; a slot surface of the clamping slot is arranged in a manner of corresponding to the surface of the fourth bulge; and when the fourth bulge is clamped into the clamping slot, the second bulge is rotated, and the fourth bulge is separated from the clamping slot.

8. The litter box according to claim 2, wherein the litter box further comprises a second supporting leg and a weighing sensor; the weighing sensor comprises a connecting part and a sensing part; the sensing part of the weighing sensor is configured to sense a change in a weight of the litter box main body; the connecting part of the weighing sensor is connected to the litter box main body; the sensing part of the weighing sensor is connected to one end of the second supporting leg; the other end of the second supporting leg is abutted with the supporting platform; the supporting platform further comprises a weighing platform; the weighing platform is mounted on the first supporting leg; one end of the second supporting leg is abutted with the weighing platform; the second supporting leg is correspondingly arranged above the first supporting leg; the litter box main body is movably mounted on the weighing platform; and one end of the second supporting leg is mounted in the mounting slot.

9. The litter box according to claim 8, wherein the weighing platform comprises a first weighing platform and a second weighing platform; the second weighing platform is mounted on the first weighing platform; the first weighing platform is provided with a first boss facing the second weighing platform; the second weighing platform is provided with a second boss; the second boss is provided with a through hole; the mounting slot is arranged on the first boss; the through hole is arranged in a manner of corresponding to the mounting slot; the second boss sleeves the first boss; the litter box main body is movably mounted on the second weighing platform; the second weighing platform is provided with the through hole; one end of the second supporting leg is mounted in the mounting slot through the through hole; and the first supporting leg is arranged below the first boss.

10. The litter box according to claim 8, wherein the connecting part is arranged at a periphery of the sensing part, and one end of the sensing part is connected to the connecting part.

11. The litter box according to claim 8, wherein the weighing sensor is a strain gauge type pressure sensor.

12. The litter box according to claim 8, wherein a hollow mounting column is arranged at a bottom of the litter box main body; the mounting column is arranged in a manner of facing the second supporting leg; a supporting rib is arranged around an inner side wall of a cavity of the mounting column; the connecting part is mounted on a supporting end of the supporting rib; the sensing part is located in the cavity of the mounting column; and when the weight of the litter box main body increases, the mounting column presses the connecting part, and the sensing part moves in the cavity of the mounting column.

13. The litter box according to claim 12, wherein a limiting column is also arranged in the cavity of the mounting column; the limiting column is arranged in a manner of corresponding to the sensing part; the limiting column is slightly lower than the supporting end of the supporting rib; and the limiting column is configured to limit the sensing part.

14. The litter box according to claim 8, wherein the litter box main body, the weighing sensor, the second supporting leg, and the supporting platform are arranged in sequence from top to bottom; a foot pad is arranged at a bottom of the first supporting leg.

15. The litter box according to claim 1, wherein the litter box main body comprises a roller and a supporting seat; the supporting seat is arranged on the supporting platform; and the supporting seat is connected to the supporting platform to form a base; the roller is rotatably arranged on the base.

16. The litter box according to claim 15, wherein the base is provided with a supporting column; a rear end surface of the roller is provided with a first gear; an upper surface of the base is sunken downwards to form an avoiding slot matched with the roller; one end of the supporting column located in the avoiding slot is opposite to an end surface of the roller; the avoiding slot is provided with a carrying slot for carrying two ends of the roller; the base is provided with a motor configured to drive the roller to rotate; a rotating shaft of the motor is connected with a second gear engaged with the first gear; the second gear is located on the carrying slot; and the roller rotates through the first gear when the motor drives the second gear to rotate.

17. The litter box according to claim 15, wherein an integral partition plate and a sifter are arranged in the roller; the integral partition plate forms an accommodating slot with an inner wall of the roller and is integrally molded with the roller; a first opening is formed in one side of the roller far from a notch of the accommodating slot; when the roller rotates, litter and waste are sifted through the sifter; and when the roller continues to rotate, the waste is rotated to the first opening along the integral partition plate.

18. The litter box according to claim 17, wherein the roller comprises a first shell and a second shell connected to the first shell; the integral partition plate comprises a first partition plate integrally molded with the first shell and a second partition plate integrally molded with the second shell; and the first partition plate and the second partition plate form the integral partition plate when the first shell is connected to the second shell.

19. The litter box according to claim 18, wherein the litter box further comprises a collection box; the collection box is arranged at a bottom of the base; a second opening communicated to the collection box is formed in the base; the roller rotates relative to the base; and when the second opening is opposite to the first opening, the waste falls into the collection box through the second opening and the first opening in sequence.

20. The litter box according to claim 19, wherein the collection box is detachably arranged at the bottom of the base.
